(19) United States
(12) Patent Application Publication
(10) Pub. No.: US 2026/0010759 A1
(43) Pub. Date: Jan. 8, 2026

(54) AI-BASED ENGINE FOR GENERATING INFORMATION ELEMENTS

(71) Applicant: TEACHERS INSURANCE AND ANNUITY ASSOCIATION OF AMERICA, New York, NY (US)

(72) Inventors: Sastry VSM Durvasula, Phoenix, AZ (US); Swatee Singh, Livingston, NJ (US); Rares Ioan Almasan, Paradise Valley, AZ (US); Sonam Jha, Short Hills, NJ (US)

(21) Appl. No.: 18/763,708

(22) Filed: Jul. 3, 2024

(51) Int. Cl. G06N 3/043; G06N 3/0475; G06N 3/092

(52) U.S. Cl. CPC G06N 3/043; G06N 3/0475; G06N 3/092

(57) ABSTRACT

An AI-based engine, system, and method for generating information elements are provided. The method may include: obtaining, by one or more processors, at least one of (a) a user profile, (b) a market performance report, (c) an industry report, or (d) a behavior report; receiving, by one or more processors, a user prompt from user interface; generating, by one or more processors, console data via an information element generative model based on the user prompt and the at least one of the user profile, the market performance report, the industry report, or the behavior report; and generating, by one or more processors, an information element based on the console data.

### TECHNICAL FIELD

The present disclosure relates to generating information elements, and, more particularly, to generating information elements using artificial intelligence (AI) techniques to perform comprehensive analysis in an efficient manner.

### BACKGROUND

Generating information elements (e.g., generating answers to questions, generating documents based on user prompts) using generative models may be challenging. For example, a generative model may generate information elements by mimicking how humans speak or write. However, a generative model may not have the capability to determine whether the fact statements in the generated information element are accurate and/or whether the logic analysis in the generated information element is valid.

Further, it is even more challenging for a generative model to generate information elements for a specialized field because the amount of public domain data is scant. Without sufficient data of a specialized field to train a generative model, the generative model is not able to generate information elements accurately. Moreover, due to the limited amount of specialized knowledge compared to general information used to train a general-purpose generative model, the generative model may confuse general information with information of the specialized field. That is, the generative model may hallucinate. For example, a user may request a generative model to provide strategies for investing in collectibles. There may not be sufficient information of strategies for investing in collectibles in the public domain. However, there may be much more information of strategies for investing in stocks. As a result, the generative model may generate a response that appears to be a strategy for investing collectible but in fact is a strategy for investing in stocks.

Conventionally, financial advisors spend significant time preparing client information, based on many sources of financial information. It is impractical for a human to monitor and analyze all relevant financial information. Human errors may be unavoidable in this time-consuming and complex process.

Accordingly, there are opportunities for techniques for generating information elements that overcome conventional problems related to generating information elements for a specialized field (e.g., finance analysis) by improving the functionalities of generative models.

### SUMMARY

In some aspects, the present techniques relate to a computing system for generating information elements, including: one or more processors; and one or more memories having stored thereon: (i) an information element generative model; (ii) a set of user profile computer-executable instructions that, when executed by the one or more processors, cause a user profile module to provide user profiles; (iii) a set of market performance report computer-executable instructions that, when executed by the one or more processors, cause a market performance module to provide market performance reports; (iv) a set of industry report computer-executable instructions that, when executed by the one or more processors, cause an industry report module to provide industry reports; (v) a set of behavior report computer-executable instructions that, when executed by the one or more processors, cause a behavior report module to provide behavior reports; (vi) a set of user interaction computer-executable instructions that, when executed by the one or more processors, cause a user interaction module to: generate a user interface; receive a user prompt via the user interface; transmit the user prompt to a neural console; receive console data from the neural console; generate an information element based on the console data; and present the information element via the user interface; and (v) a set of neural console computer-executable instructions, when executed by the one or more processors, cause the neural console to: receive at least one of (a) a user profile from the user profile module, (b) a market performance report from the market performance module, (c) an industry report from the industry report module, or (d) a behavior report from the behavior report module; receive the user prompt from the user interaction module; generate the console data via the information element generative model based on the user prompt and the at least one of the user profile, the market performance report, the industry report, or the behavior report; and transmit the console data to the user interaction module. The computing system may include additional, alternative, or fewer components.

In some aspects, the present techniques relate to a computer-implemented method for generating information elements, including: obtaining, by one or more processors, at least one of (a) a user profile, (b) a market performance report, (c) an industry report, or (d) a behavior report; receiving, by one or more processors, a user prompt from user interface; generating, by one or more processors, console data via an information element generative model based on the user prompt and the at least one of the user profile, the market performance report, the industry report, or the behavior report; and generating, by one or more processors, an information element based on the console data. The computer-implemented method may include additional, alternative, or fewer steps.

### BRIEF DESCRIPTION OF THE DRA WINGS

The figures described below depict various aspects of the system and methods disclosed therein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and instrumentalities shown, wherein:

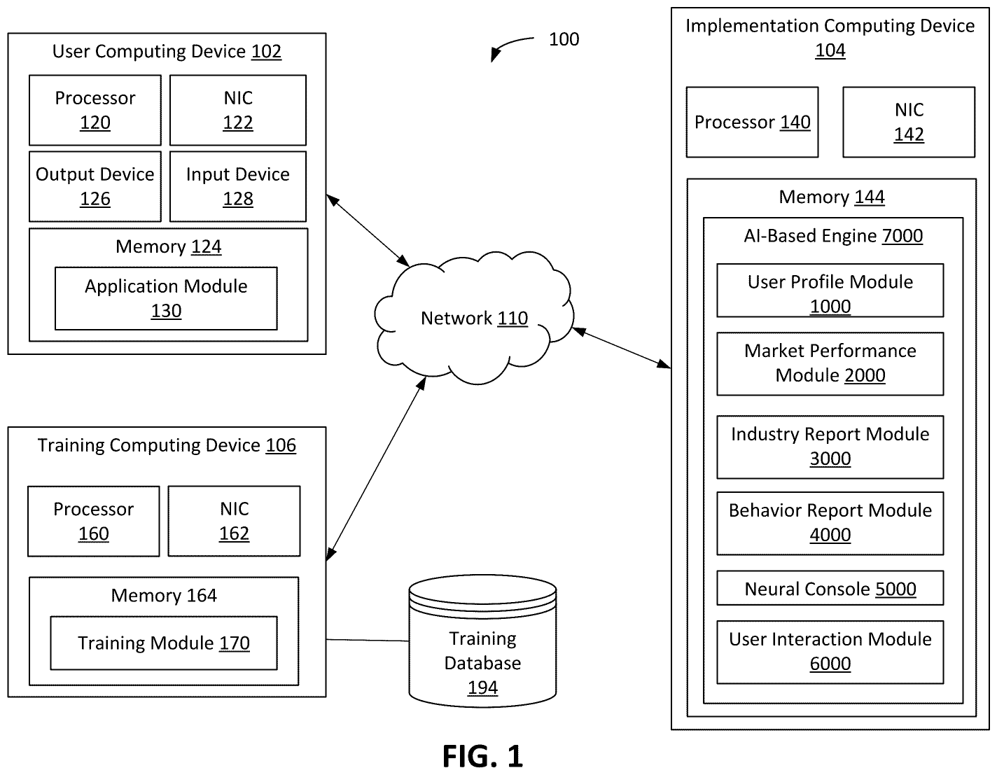

FIG. 1 depicts an exemplary computing environment in which various embodiments of the present disclosure may be implemented.

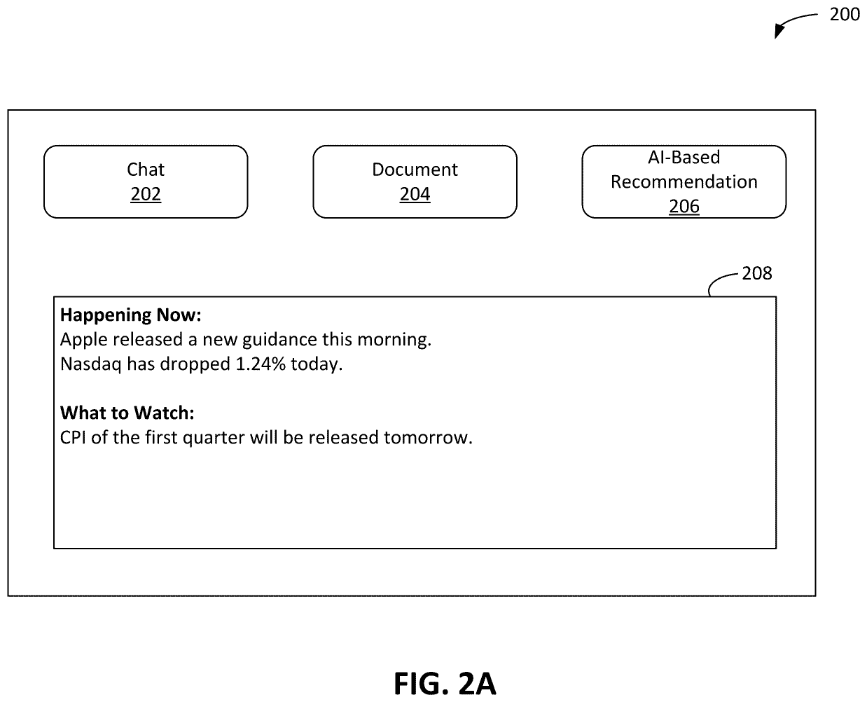

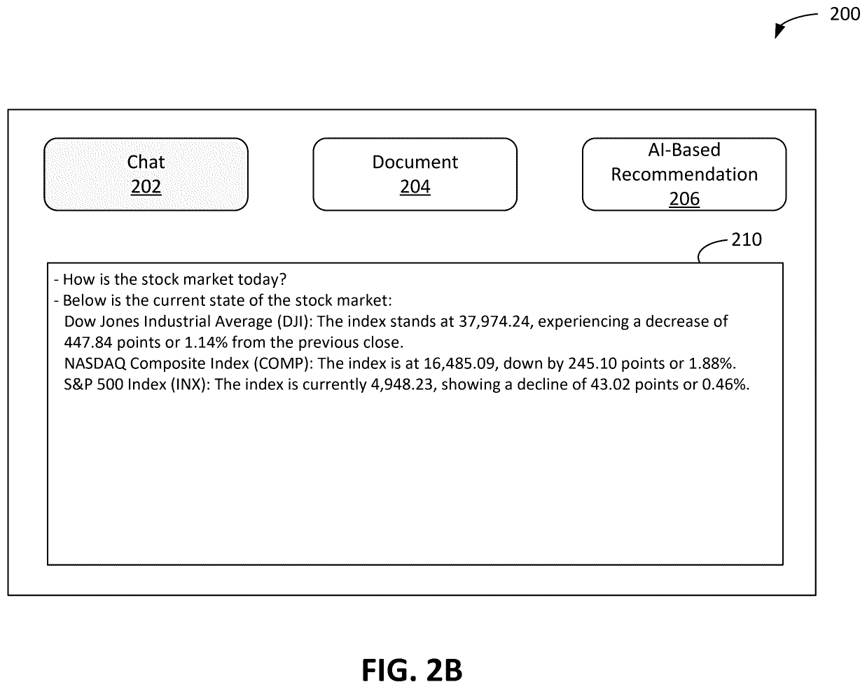

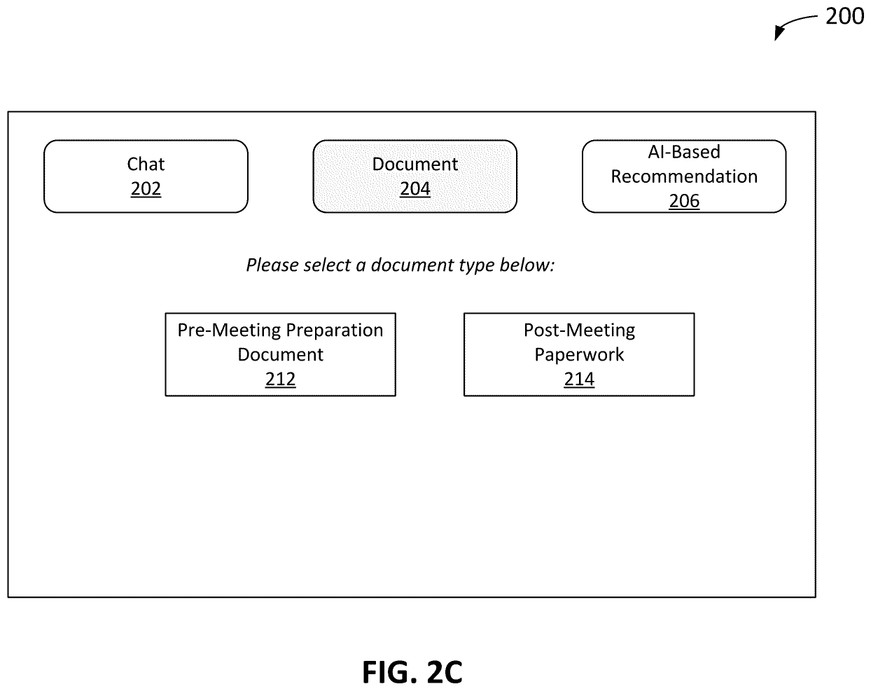

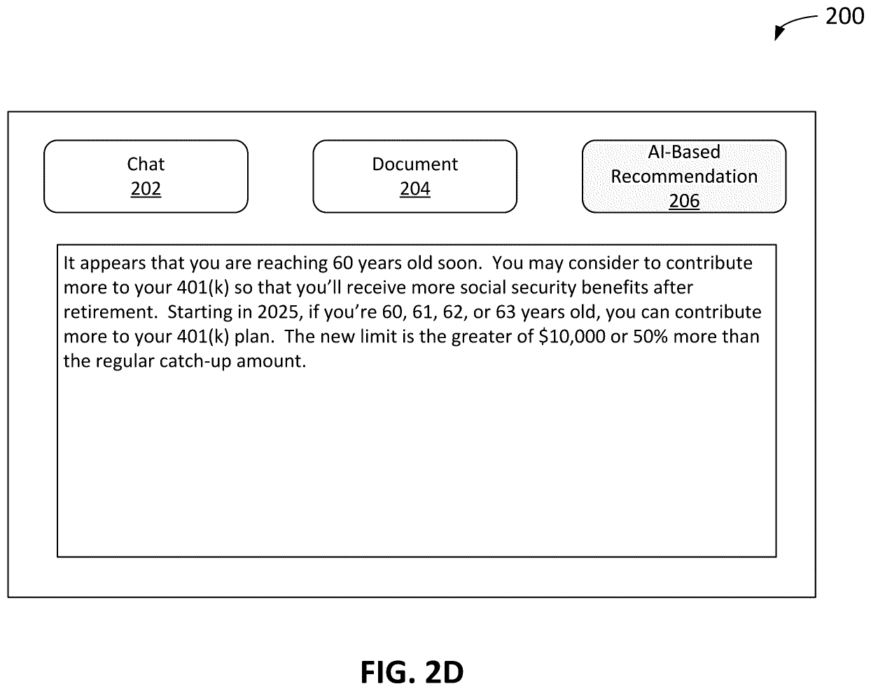

FIG. 2A depicts an exemplary graphical user interface (GUI) that may be displayed on a computing device, in accordance with various embodiments described herein.

FIG. 2B depicts an exemplary GUI similar to FIG. 2A, but in which the user has selected to chat.

FIG. 2C depicts an exemplary GUI similar to FIG. 2A, but in which the user has selected to generate documents.

FIG. 2D depicts an exemplary GUI similar to FIG. 2A, but in which the user has selected to obtain life advice.

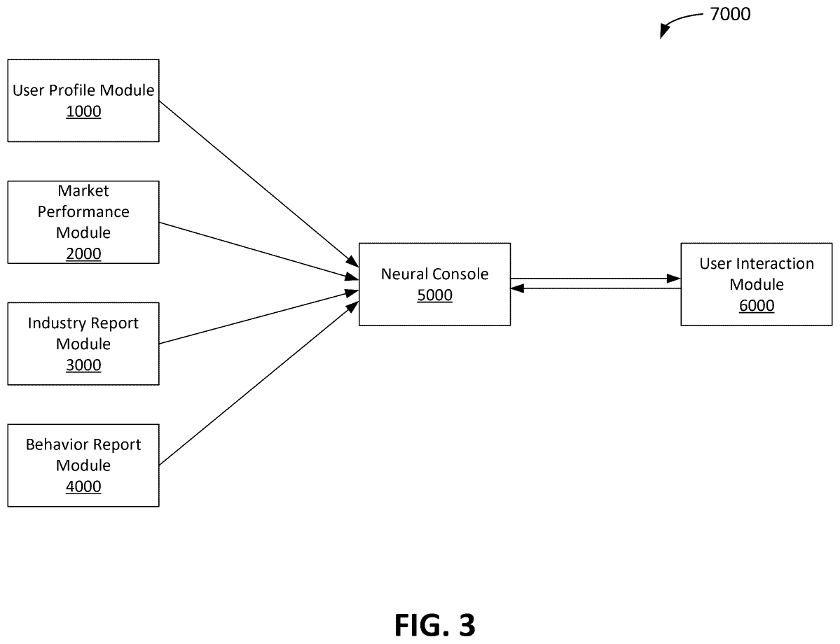

FIG. 3 is a block diagram of an example structure of an AI-based engine for generating information elements, according to some embodiments.

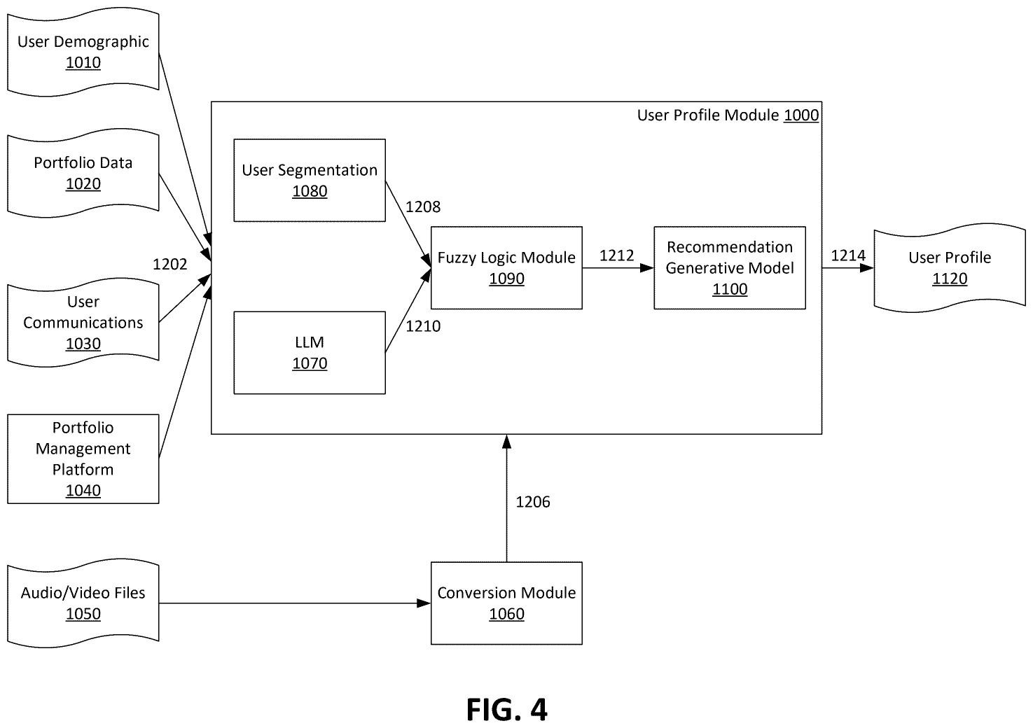

FIG. 4 is a block diagram of an example process for generating user profiles implemented by a user profile module of the AI-based engine, according to some embodiments.

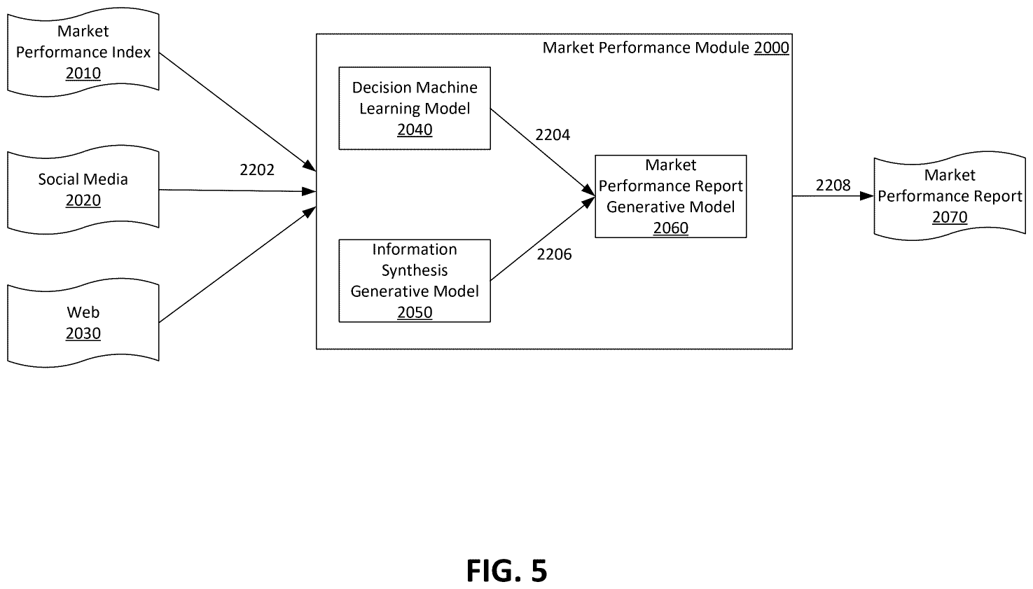

FIG. 5 is a block diagram of an example process for generating market performance reports implemented by a market performance module of the AI-based engine, according to some embodiments.

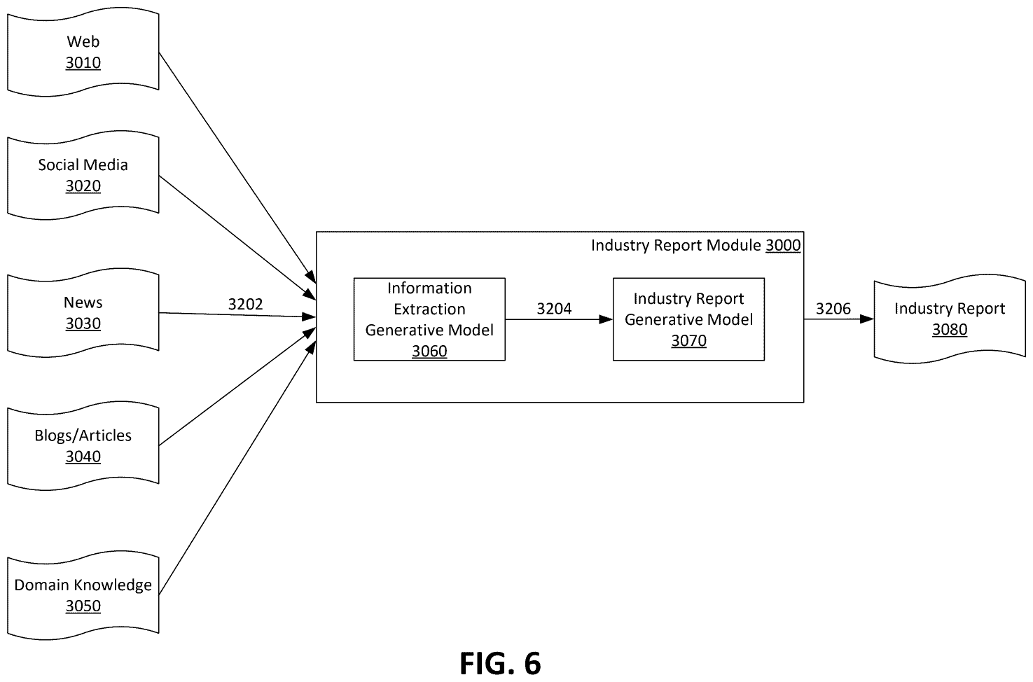

FIG. 6 is a block diagram of an example process for generating industry reports implemented by an industry report module of the AI-based engine, according to some embodiments.

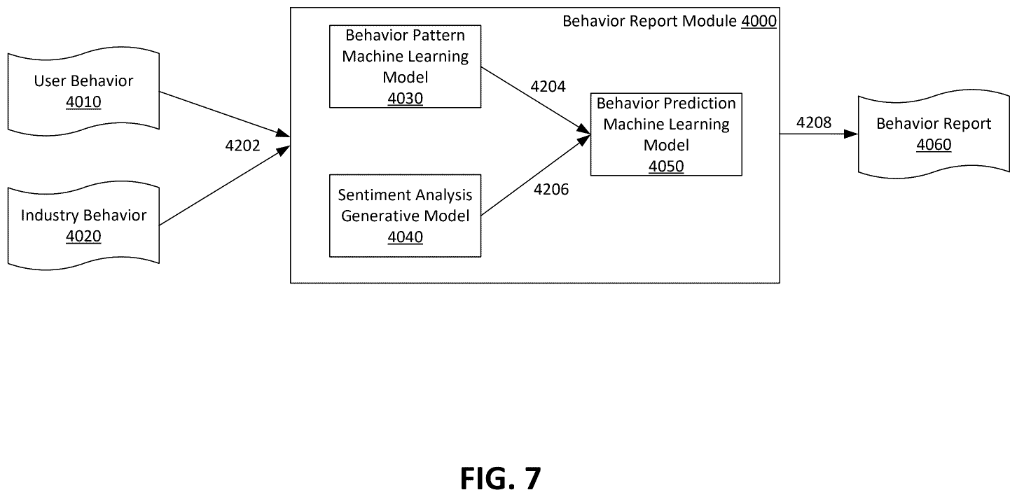

FIG. 7 is a block diagram of an example process for generative behavior reports implemented by a behavior report module of the AI-based engine, according to some embodiments.

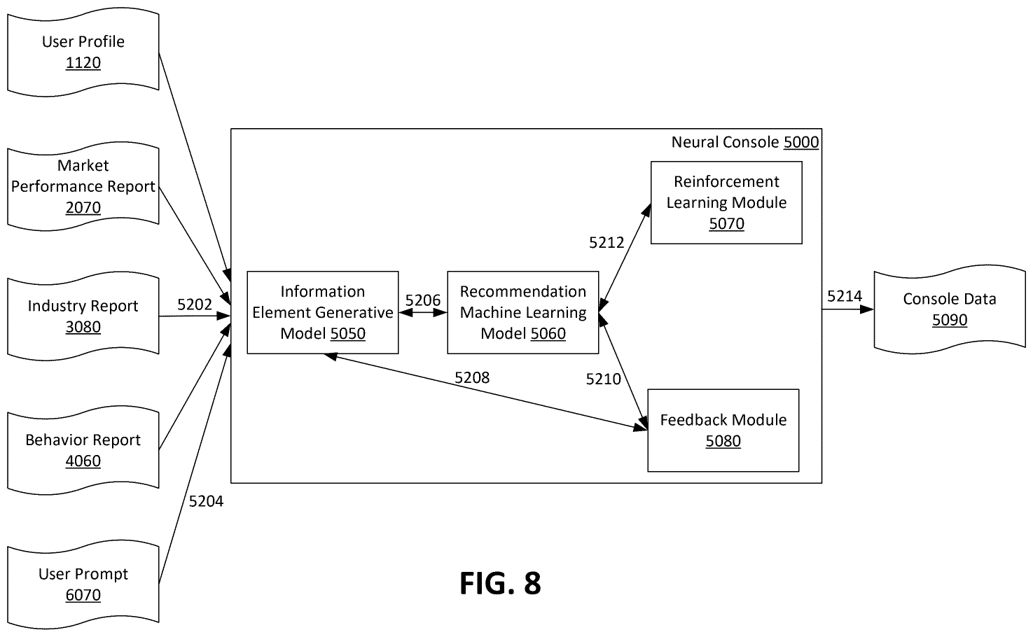

FIG. 8 is a block diagram of an example process for generating console data implemented by a neural console of the AI-based engine, according to some embodiments.

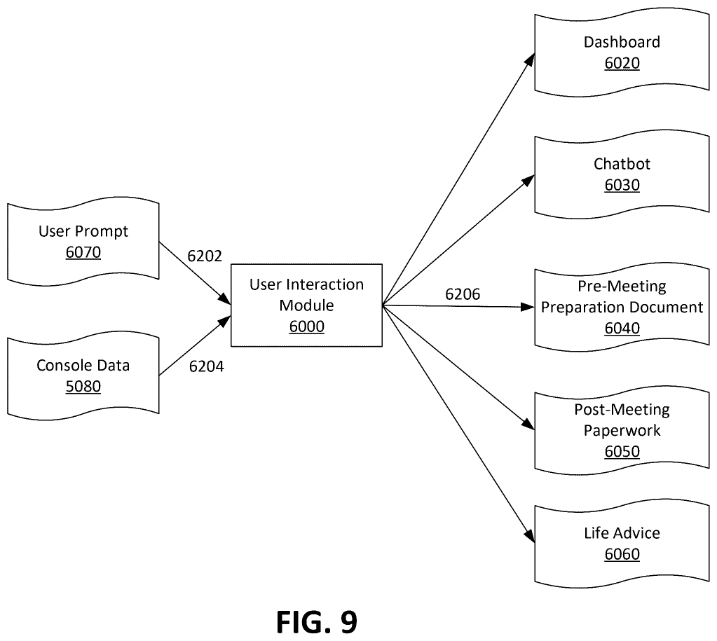

FIG. 9 is a block diagram of an example process for generating information elements implemented by a user interface module of the AI-based engine, according to some embodiments.

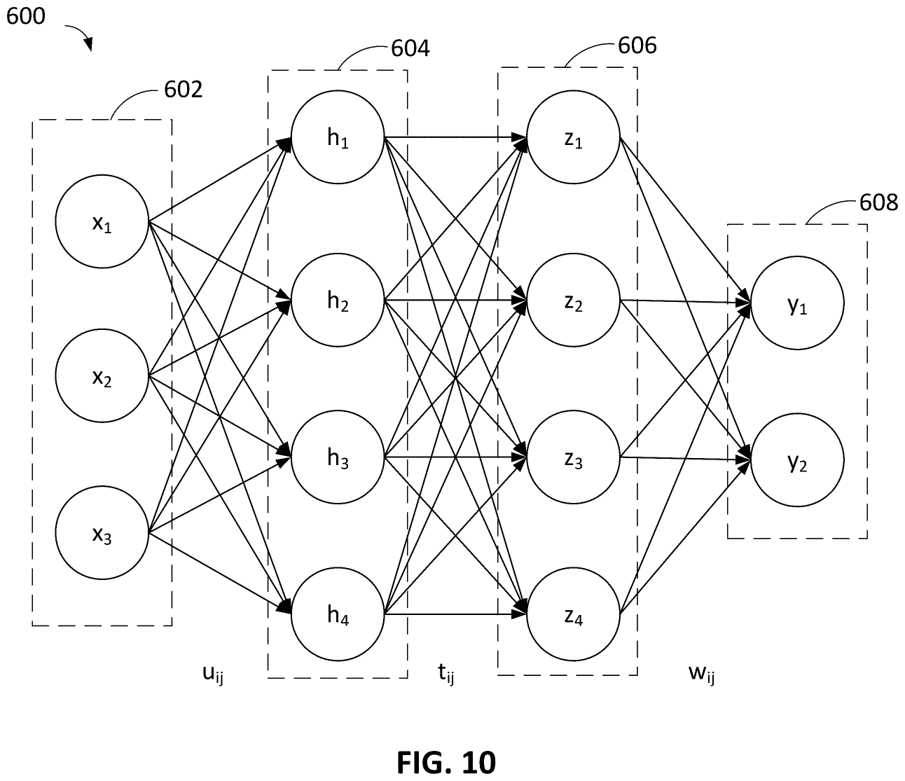

FIG. 10 depicts a structure of an example generative model to be used by techniques disclosed herein, according to some embodiments.

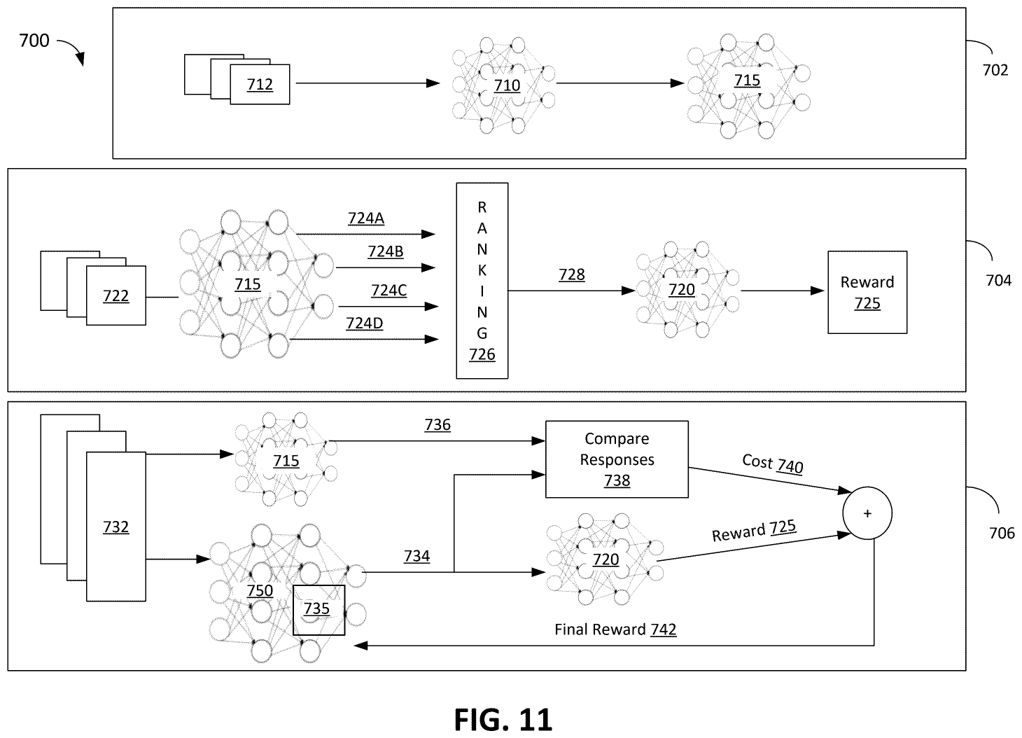

FIG. 11 depicts an example process of training an example generative model to be used by techniques disclosed herein, according to some embodiments.

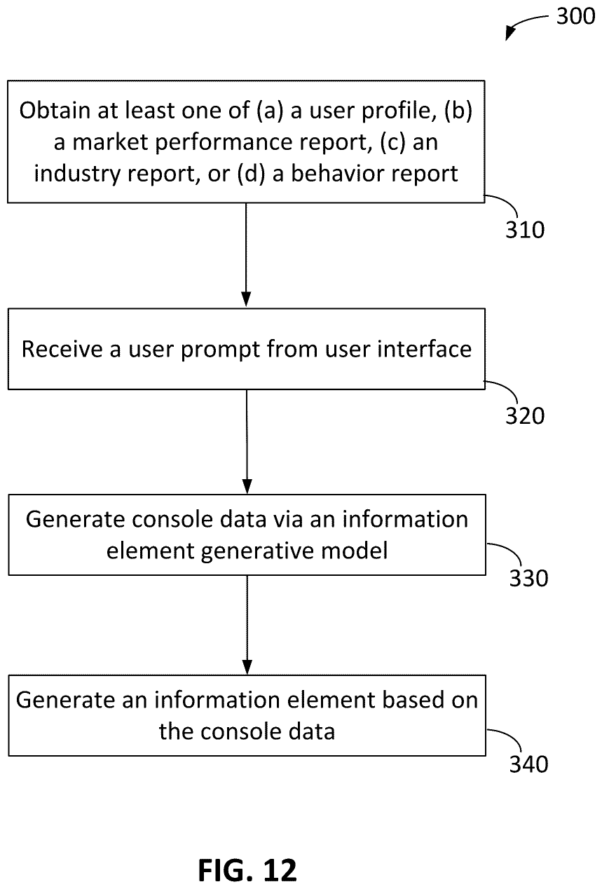

FIG. 12 is an example sequence diagram that illustrates a process for generating information elements, according to some embodiments.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

### Overview

The aspects described herein relate to, inter alia, an AI-based engine, system, and method for generating information elements.

As used herein, an “information element” refers to an answer to a user's question, a document generated based on a user's request, life advice based on a user's life event, and/or other data or documents that provide portfolio insight and/or improvement recommendations.

As used herein, a “user prompt” refers to a user input, responsive to which the AI-based engine of this disclosure may generate information elements.

The AI-based engine may monitor data from various data sources, collect data in real-time (e.g., collect immediately after the data is available or within a short period of time such as 100 milliseconds or less) or periodically, analyze the data, and generate information elements based on the data and a user prompt.

A plurality of modules of the AI-based engine may be configured to monitor, collect, and/or analyze different types of data. Advantageously, the AI-based engine collects data in real-time and/or periodically so that its analysis is based on accurate, up-to-date information. The AI-based engine is thus less likely to make factual errors because its analysis is focused on the updated data. This is different than some traditional generative models that perform analysis based on information obtained during training only.

Further, each module of the AI-based engine may include one or more machine learning models (e.g., one or more generative models), and each model may be trained to analyze a specific type of data and/or solve a specific type of problem. The models of each module may be arranged based on the functionality of the respective models.

For example, a first model of a module may receive output from a second model of the module as input. In this way, the first model is guided by the output of the second model and may perform a focused analysis. Advantageously, compared to conventional approaches, the arrangements of various models described in this disclosure may allow the overall analysis process to be more easily interpreted by humans, easier to maintain, and the analysis result is more accurate.

Additionally, the machine learning models and the generative models of this disclosure may be trained with domain knowledge for a specialized field. Some of the machine learning models and the generative models may be automatically re-trained with new data and/or new feedback such that their knowledge base and analysis capabilities may evolve with time and stay updated. Advantageously, by arranging the models of each module in a manner and training the models with domain knowledge, the models are much less likely to hallucinate, compared to general-purpose models trained in the traditional manner.

Accordingly, as described above, the disclosure provides techniques improves functionalities of generative models for generating information elements by training the generative models with specialized training data, updating source data for analysis in a timely manner, and configuring various generative models and machine learning models in a specific manner such that each model is focused on a specific problem for analysis. Therefore, the AI-based engine is not only more accurate and efficient than humans, but also more accurate and reliable than generative models configured using traditional approaches.

Other advantages of this disclosure may be apparent in view of the detailed description below.

### Exemplary Computing System

FIG. 1 illustrates an example system 100 in which one or more techniques of the present techniques may be implemented. The example system 100 may include a user computing device 102, an implementation computing device 104, a training computing device 106, and an electronic network 110. The user computing device 102, the implementation computing device 104, and the training computing device 106 may be remote from each other and are communicatively connected via the network 110.

The network 110 may be a single communication network (e.g., the Internet), and in some embodiments, the network 110 may also include one or more additional networks. As an example, the network 110 may include a cellular network, the Internet, and a server-side local area network (LAN).

The user computing device 102 may be configured to receive input from a user and present output to the user. While FIG. 1 shows only a single user computing device 102, it should be understood that the system 100 may include any suitable number of similar user computing devices operating according to the principles disclosed herein. The user computing device 102 may be or include any stationary, mobile, or portable computing device with wired and/or wireless communication capability (e.g., a smartphone, a tablet computer, a laptop computer, a desktop computer, a smart wearable device, etc.). The user computing device 102 may include a processor 120, a network interface controller (NIC) 122, and memory 124. The user computing device 102 may further include or be associated with an output device 126 and an input device 128.

The processor 120 may be a single processor (e.g., a central processing unit (CPU)), or may include a set of processors (e.g., multiple CPUs, or one or more CPUs and one or more graphics processing units (GPUs)). Although the output device 126 is depicted as part of the user computing device 102, it should be understood that the output device 126 may be external to the user computing device 102 and communicatively connected to the user computing device 102 with wires and/or the network 110.

The output device 126 may include hardware, firmware, and/or software configured to enable a user to view visual outputs of the user computing device 102, and may use any suitable display technology (e.g., LED, OLED, LCD, etc.). Moreover, in some embodiments where the user computing device 102 is a wearable device, the output device 126 may be a transparent viewing component (e.g., lenses of VR glasses) with integrated electronic components. For example, the output device 126 may include micro-LED or OLED electronics embedded in lenses of smart glasses.

The input device 128 is capable of receiving inputs from the ambient environment and/or a user, such as a keyboard, a mouse, buttons, keys, a microphone, etc. Further, the input device 128 may be integrated with the output device 126 as a touch screen having both input and output capabilities.

The NIC 122 may include hardware, firmware, and/or software configured to enable the user computing device 102 to exchange electronic data with the implementation computing device 104 via the network 110. For example, the NIC 122 may include a cellular communication transceiver, a Wi-Fi transceiver, and/or transceivers for one or more other wired and/or wireless communication technologies.

The memory 124 may include one or more computer-readable, non-transitory storage units or devices, which may include persistent (e.g., hard disk) and/or non-persistent memory components. The memory 124 may store one or more sets instructions that are executable by the processor 120 to perform various operations, including the instructions of various software applications and the data generated and/or used by such applications.

In the example embodiment of FIG. 1, the memory 124 may store at least an application module 130. The application module 130 may include instructions for receiving user prompts and presenting information elements to the user.

In some embodiments, the application module 130 may be omitted. In some embodiments, the user computing device 102 may be omitted. That is, the implementation computing device 104 may receive user prompts and present information elements to the user directly.

The implementation computing device 104 may be configured to generate information elements. The implementation computing device 104 may include a processor 140, a network interface controller (NIC) 142, and memory 144.

The processor 140 may include one or more processors. The implementation computing device 104 may include one or more servers, for example, which may reside at a single location or multiple locations. In some embodiments, the implementation computing device 104 may be a cloud or virtualized component.

The NIC 142 may include hardware, firmware, and/or software configured to enable the implementation computing device 104 to exchange electronic data with the user computing device 102 and other devices via the network 110. For example, the NIC 142 may include a wired or wireless router and a modem.

The memory 144 may be a computer-readable, non-transitory storage unit or device, or collection of units/devices, which may include persistent and/or non-persistent memory components. The memory 144 may have stored thereon an AI-based engine 7000. The AI-based engine 7000 may include a user profile module 1000, a market performance module 2000, an industry report module 3000, a behavior report module 4000, a neural console 5000, and a user interaction module 6000.

The user profile module 1000 generally includes instructions for generating user profiles. The user profile module 1000 may include components as discussed below with respect to FIG. 4. The user profile module 1000 may include additional, alternative, or fewer components.

The market performance module 2000 generally includes instructions for generating market performance reports. The market performance module 2000 may components as discussed below with respect to FIG. 5. The market performance module 2000 may include additional, alternative, or fewer components.

The industry report module 3000 generally includes instructions for generating industry reports. The industry report module 3000 may include components as discussed below with respect to FIG. 6. The industry report module 3000 may include additional, alternative, or fewer components.

The behavior report module 4000 generally includes instructions for generating behavior reports. The behavior report module 4000 may include components as discussed below with respect to FIG. 7. The behavior report module 4000 may include additional, alternative, or fewer components.

The neural console 5000 is a computer module generally including instructions for generating console data. The console data may be used for generating information elements by the user interaction module 6000. The neural console 5000 may include components as discussed below with respect to FIG. 8. The neural console 5000 may include additional, alternative, or fewer components. For example, briefly referring to FIG. 8, the reinforcement learning module 5070 and the feedback module 5080 may be omitted after the information element generative model 5050 and the recommendation machine learning model 5060 are well trained. Alternatively, the neural console 5000 may keep the reinforcement learning module 5070 and the feedback module 5080 to continue to update the information element generative model 5050 and recommendation machine learning model 5060 to allow them to evolve with time and new feedback.

Turning back to FIG. 1, the user interaction module 6000 generally includes instructions for receiving user prompts and generating information elements. Although depicted as being stored on the implementation computing device 104, the user interaction module 6000 may instead be a module of the application module 130 of the user computing device 102. When the user interaction module 6000 is being stored on the implementation computing device 104, the user interaction module 6000 may include instructions for receiving user prompts from the user computing device 102, generating information elements based on console data generated by the neural console 5000, and transmitting the information elements to the user computing device 102. When the user interaction module 6000 is being stored on the user computing device 102, the user interaction module 6000 may include instructions for generating a user interface, receiving user prompts via the user interface, generating information elements based on console data received from the implementation computing device 104, and presenting the information elements via the user interface.

Each of the modules 1000-6000 may include instructions for accessing a training database 194 (described below) to retrieve sample data from training database 194 for training machine learning models and/or generative models of the modules 1000-6000. Such instructions may include SQL or NoSQL scripts (e.g., queries) for accessing a relational database and/or a NoSQL (e.g., Mongo DB) database. Internal structures and training processes of the generative models will be described below with respect to FIGS. 10 and 11.

The training computing device 106 may be configured to train the machine learning models and/or the generative models described above. The training computing device 106 may include a processor 160, a network interface controller (NIC) 162, and memory 164. The processor 160 may be configured in a similar manner as described above with respect to the processor 140. The NIC 162 may be configured in a similar manner as described above with respect to the NIC 142. In some embodiments, the training computing device 106 may include or communicatively connected to a training database 194.

The memory 164 is a computer-readable, non-transitory storage unit or device, or collection of units/devices, that may include persistent and/or non-persistent memory components. The memory 164 may store the instructions of a training module 170.

The training module 170 may include instructions for training the one or more machine learning models and/or generative models to be used by the implementation computing device 104. The training computing device 106 may train and/or re-train the AI models using the training data set in the training database 194. Although the reinforcement learning module 5070 and the feedback module 5080 are depicted as part of the neural console neural console 5000, they may be instead stored on the training computing device 106 as part of the training module 170 for the purposes of training and/or continuously training the information element generative model 5050 and recommendation machine learning model 5060.

The details for training generative models will be described in detail below with respect to FIGS. 10 and 11. After the machine learning models and the generative models are trained, the implementation computing device 104 may retrieve the trained machine learning models and generative models from the training computing device 106 and use them when needed.

In some embodiments, the training computing device 106 may be omitted. In such embodiments, the implementation computing device 104 may include the training module 170 to train the machine learning models and the generative models thereby.

### Exemplary Graphical User Interfaces (GUIs)

FIGS. 2A-2D depict an exemplary GUI 200 that may be displayed on a computing device (such as the user computing device 102), in accordance with various embodiments described herein.

As shown in FIG. 2A, initially, the GUI 200 presents a dashboard including selectable elements 202-206. The dashboard may also include a news window 208 for presenting real-time news.

Turning to FIG. 2B, responsive to a user selecting the selectable element 202 “Chat,” the GUI 200 generates a conversation window 210. The user may input any question, including but not limited to general financial questions, advice for the user based on the user profile, etc. In response, the GUI 200 will present an answer to that the question. The process of generating the answer will be described below in detail.

Turning to FIG. 2C, responsive to a user selecting the selectable element 204 “Document,” the GUI 200 presents selectable elements 212 and 214 for the user to select a document type to be generated. Although only two document types are shown in FIG. 2C, other document types (such as presentation slides, presentation videos, etc.) are also envisioned. Upon the user selecting a document, the GUI 200 may present a window (not depicted) to allow the user to provide more detail regarding the document to generated. When the document type is a pre-meeting preparation document, the detail may include a topic for the meeting, talk points for the meeting, relevant industry and timeframe for financial analysis, etc. A pre-meeting preparation document may include information generated based on the topic or talk points. In some embodiments, the pre-meeting preparation document may include a set of slides for presenting such information in a meeting. When the document type is post-meeting paperwork, the detail may include a transcript or notes of the meeting. For example, the GUI 200 may allow the user to upload documents including meeting transcripts and/or notes. The process of generating the documents will be described below in detail. The post-meeting paperwork may include paperwork generated based on action items detected from the meeting transcripts or notes. The post-meeting paperwork may also be automatically filled with information extracted from the meeting transcripts or notes and/or information from the system, including user information, market information, industry information, etc.

Turning to FIG. 2D, responsive to a user selecting the selectable element 206 “Recommendation,” the GUI 200 presents an AI-based recommendation based on the user's recent life events and/or user profile. The process of generating the recommendation will be described below in detail.

### Example Engine and Implementation Process

FIG. 3 is a block diagram of an example structure of an AI-based engine 7000 for generating information elements, according to some embodiments.

The AI-based engine 7000 may include a user profile module 1000, a market performance module 2000, an industry report module 3000, a behavior report module 4000, a neural console 5000, and a user interaction module 6000. Each of the modules 1000-6000 includes a set of instructions that, when executed by one or more processors (such as the processor 140), cause the processors to perform a set of actions, as will be described below in detail.

In general, the neural console 5000 may receive a user prompt from the user interaction module 6000. In some embodiments, the neural console 5000 may receive user profiles from the user profile module 1000, market performance reports from the market performance module 2000, industry reports from the industry report module 3000, and behavior reports from behavior report module 4000 periodically or responsive to there is a new profile or report generated by the modules. In other embodiments, the neural console 5000 may retrieve user profiles or reports from the modules 1000-4000 responsive to the user prompt. For example, the neural console 5000 may determine that a question in the user prompt is relevant to a market performance report, the neural console 5000 may retrieve relevant market performance reports from the market performance module 3000 accordingly.

In some embodiments, after receiving the user profiles and/or the reports, the neural console 5000 may generate console data based on the user profiles and/or the reports and the user prompt. The neural console 5000 may transmit the console data to the user interaction module 6000. The user interaction module 6000 may generate information elements based on the console data. In other embodiments, the neural console 5000 may generate information elements and transmit the information elements to the user interaction module 6000. In either embodiment, the user interaction module 6000 may present the information elements to a user.

FIG. 4 is a block diagram of an example process for generating user profiles implemented by a user profile module 1000 of the AI-based engine 7000, according to some embodiments.

The user profile module 1000 may include a large language model (LLM) 1070, a user segmentation module 1080, a fuzzy logic module 1090, and a recommendation generative model 1100. The user profile module 1000 may include additional, alternative, or fewer components.

The example process may begin with the user profile module 1000 receiving (1202) user demographics 1010, portfolio data 1020, user communications 1030 and/or other user information. The user demographics 1010 may include information such as a user's age, gender, ethnicity, marriage status, annual income, occupation, etc. The portfolio data 1020 may include a user's bank account information, income information, etc. The user communications 1030 may include historical communications between the user and a representative of an enterprise.

In some embodiments, the user profile module 1000 may use a portfolio management platform 1040 to monitor various data sources providing the user demographics 1010, the portfolio data 1020, the user communications 1030 and/or other user information. More specifically, the portfolio management platform 1040 may retrieve the user demographics 1010, the portfolio data 1020, the user communications 1030 and/or other user information from various data sources periodically. Alternatively, the portfolio management platform 1040 may retrieve the user demographics 1010, the portfolio data 1020, the user communications 1030 and/or other user information from various data sources when it detects there is an update to these data. In either scenario, the portfolio management platform 1040 may retrieve the new data from the various data sources only. In some embodiments, the user profile module 1000 includes the portfolio management platform 1040.

In some embodiments, the user demographics 1010, the portfolio data 1020, the user communications 1030 and/or other user information may include audio or video files 1050. A conversion module 1060 may convert the audio or video files to texts and then transmit (1206) the texts to the user profile module 1000. In some embodiments, the user profile module 1000 may include the conversion module 1060.

In some embodiments, when the portfolio management platform 1040 detects an update of at least one of the user demographics 1010, the portfolio data 1020, the user communications 1030 and/or other user information, the portfolio management platform 1040 retrieves the update of user data and transmits (1202) the update to the user profile module 1000. The user profile module 1000 may use the LLM 1070 to extract information from the update of the user data and synthesize the extracted information with existing user information to generate updated user information. As an example, the portfolio management platform 1040 may detect an update of the user demographic 1010 that shows the user has moved from a first location to a second location. The user profile module 1000 may extract the second location from the update of the information via the LLM 1070 and synthesizes the user's new location with existing information of the user. As another example, the portfolio management platform 1040 may detect an update of the user communications 1030 that shows the user has a new preference for investment risks. The user profile module 1000 may extract the new preference from the update of the information via the LLM 1070 and synthesizes the user's new preference with existing information of the user. The internal structure and training process of the LLM 1070 will be described with respect to FIGS. 10 and 11.

The user profile module 1000 may have stored thereon (e.g., at the user segmentation module 1080) a plurality of user segmentations. Each user may be assigned to one or more user segmentations. The plurality of user segmentations may be based on geographic locations, ages, incomes, risk preferences, etc. In some embodiments, the segmentations may be self-learned by the user profile module 1000 using machine learning or artificial intelligence techniques. For example, an update of user information may include a metric that does not fit in existing user segmentations. The user profile module 1000 may generate a new user segmentation using semantic analysis (e.g., using Bidirectional Encoder Representations from Transformers (BERT) embeddings or other appropriate language models) or other analysis techniques based on the update of user information. In this way, user segmentations may evolve with time.

Based on the update of user information, the user profile module 1000 may determine or update one or more user segmentations of the user via the user segmentation module 1080. As an example, if the update of user information and/or the updated user information shows that the user has moved from a first location to a second location, the user segmentation module 1080 may assign the user to a user segmentation corresponding to the second location. As another example, if the update of user information and/or the updated user information shows that the user has a new investment risk preference, the user segmentation module 1080 may assign the user to a user segmentation corresponding to the new investment risk preference.

The LLM 1070 may transmit (1210) the updated information to the fuzzy logic module 1090. The user segmentation module 1080 may transmit (1208) the user's one or more user segmentations to the fuzzy logic module 1090. Based on the updated user information and the user's one or more user segmentations, the user profile module 1000 may discover a data pattern via the fuzzy logic module 1090. The fuzzy logic module 1090 is generally configured to perform fuzzy logic analysis. The fuzzy logic module 1090 may discover how users of a particular user segmentation tend to act after life events similar to the update of the user information. The fuzzy logic module 1090 may further discover how users' financial situation changes after the users' actions.

The fuzzy logic module 1090 may transmit (1212) the discovered data pattern to the recommendation generative model. Based on the discovered data pattern, the recommendation generative model 1100 may generate a report, a recommended action, and/or a user profile improvement recommendation. The report may summarize the update of user information and/or data pattern discovered based on the user information. The recommended action may be an action for improving the user's financial status. The profile improvement recommendation may be a suggestion to improve the user's profile. The discovered data pattern may improve the quality of recommendations generated by the recommendation generative model 1100 because the recommendation generative model 1100 may be focused on the discovered pattern, and thereby generate recommendations that fit the user's situation.

The user profile module 1000 may then generate (1214) a user profile including the report, the recommended action, or the user profile improvement recommendation. The user profile module 1000 may transmit the user profile to the neural console 5000.

FIG. 5 is a block diagram of an example process for generating market performance reports implemented by a market performance module 2000 of the AI-based engine 7000, according to some embodiments.

The market performance module 2000 may include a recommendation machine learning model 2040, an information synthesis generative model 2050, and a market performance report generative model 2060. The market performance module 2000 may include additional, alternative, or fewer components.

The example process may begin with the market performance module 2000 receiving (2202) market performance indices 2010, social media information 2020, and web information 2030. The market performance indices 2010 may include stock market indices (such as Nasdaq Composite, S&P 500, etc.), industry product or consumer product prices (such as prices of gasoline), and/or other economic indices (such as Consumer Price Index (CPI), Producer Price Index (PPI), interest rate, etc.). Social media information 2020 may include texts, images, and/or videos posted on social media that indicate market sentiment. Web information 2030 may include texts, images, and/or videos published on webpages that indicate updates of products or services.

In some embodiments, the market performance module 2000 may use an application programming interface (API) or a software component to monitor the market performance indices 2010, social media information 2020, and web information 2030. The market performance module 2000 may retrieve the market performance indices 2010 and social media information 2020 in real time. The market performance module 2000 may retrieve web information 2030 periodically (e.g., hourly).

Upon the market performance module 2000 receiving (2202) the market performance indices 2010, social media information 2020, and/or web information 2030, the decision machine learning model 2040 may analyze the market performance indices. In some embodiment, the decision machine learning model 2040 may decide a set of metrics for describing the market performance based on the market performance indices. For example, the metrics may include a current status (e.g., a bull market, a bear market, or a neutral market), an expectation (e.g., positive, negative, or neural), etc. In some embodiments, the recommendation machine learning model 2040 is a decision tree model. An advantage of using a decision tree model is that it allows the process of decision making to be transparent to auditors. The recommendation machine learning model 2040 may be trained with sample portfolio data and a plurality of sample metrics associated with respective portfolio data.

The information synthesis generative model 2050 may synthesize social media information 2020 and web information 2030 to generate synthesized information. For example, synthesized information may include investors' and the industry's sentiment, etc.

The recommendation machine learning model 2040 may transmit (2204) the recommended action to the market performance report generative model 2060. The information synthesis generative model 2050 may transmit (2206) the synthesized information to the market performance report generative model 2060. The market performance report generative model 2060 may summarize the market performance information received from recommendation machine learning model 2040 and the information synthesis generative model 2050, and generate (2208) a market performance report 2070 including the summary and a recommended action based on the recommended action and the synthesized information. For example, if the combination of the market index analysis by the decision machining model 2040 and the sentiment analysis by the information synthesis generative model 2050 shows there is likely a bubble in the current market (e.g., the sentiment is unreasonably positive in view of the expectation extrapolated by the market indices), the market performance report generative model 2060 may recommend a conservative investment strategy.

An advantage of using the recommendation learning model 2040, the information synthesis generative model 2050, and the market performance report generative model 2060 is that this arrangement of models allows each model to perform a focused analysis based on their respective specific input prompt. The market performance report generative model 2060 is guided by the output of the recommendation learning model 2040 and the information synthesis generative model 2050 to generate the market performance report 2070. In this way, the market performance report generative model 2060 may generate market performance reports more accurately than an unguided, generally trained generative model. The internal structure and training process of the information synthesis generative model 2050 and other generative models of this disclosure will be described with respect to FIGS. 10 and 11.

The market performance module 2000 may transmit the market performance report 2070 to the neural console 5000.

FIG. 6 is a block diagram of an example process for generating industry reports implemented by an industry report module 3000 of the AI-based engine 7000, according to some embodiments.

The industry report module 3000 may include an information extraction generative model 3060 and an industry report generative model 3070. The industry report module 3000 may include additional, alternative, or fewer components.

The example process may begin with the industry report module 3000 receiving (3202) web information 3010, social media information 3020, news 3030, blogs or articles 3040, and domain knowledge 3050. The web information 3010 may include product updates, industry updates, etc. the social media information 3020 may include market sentiment with respect to an industry. The news 3030 may include industry news. The blogs or articles 3040 may include reports and/or comments on product or industry updates. The domain knowledge 3050 may include professional knowledge and/or privately held knowledge regarding an industry.

The industry report module 3000 may retrieve the social media information 3020 and news 3030 in real time. The industry report module 3000 may retrieve the web information 3010, the blogs or articles 3040, and the domain knowledge 3050 periodically (e.g., hourly).

Upon receiving the web information 3010, the social media information 3020, the news 3030, the blogs or articles 3040, and/or domain knowledge 3050, the industry report module 3000 may use an information extraction generative model 3060 to extract information on an industry topic from the web information 3010, the social media information 3020, the news 3030, the blogs or articles 3040, and/or domain knowledge 3050. For example, the news 3030 may report that a car manufacturer has started to sell a new model of cars. The information extraction generative model 3060 may extract information of the new model of cars from the news 3030 when the industry topic is relevant to a car industry.

In some embodiments, the industry report module 3000 retrieves the web information 3010, the social media information 3020, the news 3030, the blogs or articles 3040, and/or domain knowledge 3050 based on an industry topic selected by a user or a computing system (such as the AI based on engine 7000). The information, such as pieces of news, may be associated with labels. The industry report module 3000 may retrieve news associated with labels that match the industry topic.

In some embodiments, a piece of news may not be associated with any labels. A generative model (such as the information extraction generative model 3060) may generate one or more candidate labels based on a title, a content, and/or a news source of the piece of news. The generative model may further generate or determine confidence levels for each of the one or more candidate labels. The industry report module 3000 may then select at least one label to be associated with the piece of news based on the confidence levels. For example, the industry report module 3000 may select labels with confidence levels that are above a predetermined confidence level threshold. Alternatively or additionally, the industry report module 3000 may select labels with highest confidence levels.

The information extraction generative model 3060 may transmit (3204) the extracted information to the industry report generative model 3070. The industry report generative model 3070 may generate (3206) an industry report 3080 based on the extracted information. More specifically, the industry report generative model 3070 may synthesize and summarize the extracted information. The report may include the synthesized and summarized industry information and provides insights on the industry performance. The industry report module 3000 may then transmit the industry report 3080 to the neural console 5000.

FIG. 7 is a block diagram of an example process for generative behavior reports implemented by a behavior report module 4000 of the AI-based engine 7000, according to some embodiments.

The behavior report module 4000 may include a behavior pattern machine learning model 4030, a sentiment analysis generative model 4040, and a behavior prediction machine learning model 4050. The behavior report module 4000 may include additional, alternative, or fewer components.

The example process may begin with the behavior report module 4000 receiving (4202) user behavior information 4010 and industry behavior information 4020. The user behavior information 4010 may include behavior information and user sentiment information collected from client communications. AS an example, the user may have indicated to be interested in taking a particular retirement in a past communication with a representative of an enterprise. The user's indication in taking the particular retirement may be user behavior information. As another example, the user may have indicated to be positive in the future of an industry in a past communication with a representative of an enterprise. The user's indication may be user sentiment information. The industry behavior information 4020 may include product updates, industry updates, and/or people's sentiment regarding the industry, collected from webpages and social media, similar to web information 3010 and social media information 3020 described above.

Upon receiving the user behavior information 4010 and the industry behavior information 4020, the behavior pattern machine learning model 4030 may discover a behavior pattern from at least one of the user behavior information 4010 and the industry behavior information 4020. For example, the behavior pattern machine learning model 4030 may discover what actions users tend to take in response to an industry behavior based on the user behavior information 4010 and the industry behavior information 4020. In some embodiments, the behavior pattern machine learning model 4030 is a neural network model 4030. The behavior pattern machine learning model 4030 may be trained with sample behavior data and sample behavior patterns associated with respective behavior data.

Upon receiving the user behavior information 4010 and the industry behavior information 4020, a sentiment analysis generative model 4040 may perform a sentiment analysis on at least one of the user behavior information 4010 and the industry behavior information 4020 to obtain an analysis result. For example, the sentiment analysis generative model 4040 may extract sentiment information from at least one of the user behavior information 4010 and the industry behavior information 4020 and summarize the sentiment information. The sentiment analysis generative model 4040 may further analyze whether the user sentiment is consistent with the industry sentiment.

The behavior pattern machine learning model 4030 may transmit (4204) the behavior pattern to the behavior predication machine learning model 4050. The sentiment analysis generative model 4040 may transmit (4206) the analysis result to the behavior predication machine learning model 4050. The behavior predication machine learning model 4050 may predict at least one of a future industry behavior or a future user behavior. For example, if the industry sentiment regarding future market is positive, the behavior predication machine learning model 4050 may predict the industry will make further investment to increase production capabilities. In some embodiments, the behavior pattern machine learning model 4030 is a random forest model. The behavior predication machine learning model 4050 may be trained with sample behavior pattern and sample sentiment analysis results, and sample behavior predictions associated with respective sample behavior pattern and sample sentiment analysis results.

The behavior report module 4000 may generate (4208) a behavior report 4060 including (a) at least one of the user behavior or the industry behavior (e.g., current behaviors) and (b) at least one of the future user behavior or the future industry behavior. The behavior report module 4000 may transmit the behavior report 4060 to the neural console 5000.

FIG. 8 is a block diagram of an example process for generating console data implemented by a neural console 5000 of the AI-based engine 7000, according to some embodiments.

The neural console 5000 may include an information element generative model 5050, a recommendation machine learning model 5060, a reinforcement learning module 5070, and a feedback module 5080. The neural console 5000 may include additional, alternative, or fewer components.

The example process may begin with the neural console 5000 receiving (5202) at least one of the customer profile 1120 from the user profile module 1000, the market performance report 2070 from the market performance module 2000, the industry report 3080 from the industry report module 3000, or the behavior report 4060 from the behavior report module 4000. The neural console 5000 may also receive (5204) a user prompt 6070 from the user interaction module 6000.

In some embodiments, the information element generative model 5050 of the neural console 5000 may generate an information element based on (i) the at least one of the customer profile 1120, the market performance report 2070, the industry report 3080, or the behavior report 4060 and (ii) the user prompt 6070. The information element may include an answer to a question as will be presented in a chatbot, a document for meeting preparations, and/or a life advice to a user. The information element may correspond to the user prompt 6070, as will be described with respect to FIG. 9.

In some embodiments, instead of generating an information element, the information element generative model 5050 may generate console data 5090, based on which the user interaction module 6000 is capable of generating an information element. For example, the console data 5090 may include texts and formats based on which the user interaction module 6000 may generate formatted text in a chatbot conversion window. As another example, the console data 5090 may include a computer-executable script that, when executed by the user interaction module 6000, causes the user interaction module 6000 to generate a document.

In some embodiments, the information element generative model 5050 may communicate (5206) with the recommendation machine learning model 5060. For example, the recommendation machine learning model 5060 may determine a recommended action based on the user prompt and the at least one of the customer profile 1120, the market performance report 2070, the industry report 3080, or the behavior report 4060. If the user prompt is a life event, the recommended action may be a new financial strategy in view of the user's life event. If the user prompt is a question regarding the user's financial situation, the recommended action may be a piece of advice on how to improve the user's financial situation. The recommended action should be reasonable in view of the at least one of the customer profile 1120, the market performance report 2070, the industry report 3080, or the behavior report 4060. In some embodiments, the recommendation machine learning model 5060 is a decision tree model. In this way, the process of how the recommended action is determined may be transparent to auditors. The recommendation machine learning model 5060 may be trained with sample input data, including sample console data, sample information elements, sample user prompts, sample customer profiles, sample market performance reports, sample industry reports, and/or sample behavior reports, and sample recommendations associated with respective the sample input data.

The information element generative model 5050 may receive the on the recommended action from the recommendation machine learning model 5060 and generate an information element or console data 5090 based on the recommended action. In this way, the information element or the console date 5090 may include a recommendation to the user.

In some embodiments, the recommendation machine learning model 5060 may determine a recommended action based on the information element or the console data 5090 received from the information element generative model 5050. For example, the information element or the console data 5090 may include an analysis based on a user prompt, such as an analysis of the user's current financial situation or an analysis of a current market performance. In addition to the at least one of the customer profile 1120, the market performance report 2070, the industry report 3080, or the behavior report 4060, the recommendation machine learning model 5060 may further determine a recommended action based on the analysis in the information element or console data 5090. The recommendation machine learning model 5060 may then transmit the recommended action to the information element generative model 5050. In response, the information element generative model 5050 may update the information element or the console data 5090 by incorporating the recommended action into the information element or the console data 5090.

In some embodiments, the information element generative model 5050 may transmit (5208) the information element or the console data 5090 to the feedback module 5080. The recommendation machine learning model 5060 may transmit (5210) the recommended action to the feedback module 5080. The feedback module 5080 may evaluate the information element or the console data 5090 and the recommended action.

In some embodiments, the information element or the console data 5090 and the recommended action are evaluated by human experts via the feedback module 5080. For example, the information element generative model 5050 may transmit the information element or the console data 5090 to the feedback module 5080. A human expert may evaluate the information element or the console data 5090 based on domain knowledge and provide feedback. The feedback may be a scalar value. Based on the feedback, the information element generative model may update its parameters such that it may be more likely to generate an information element or console data 5090 that receives positive feedback or maximum value as feedback. The recommendation machine learning model 5060 may be updated in a similar based on human feedback from the feedback module 5080.

In some embodiments, the recommended action is evaluated by a reinforcement learning module 5070. The reinforcement learning module 5070 may include a set of policies for evaluating a recommended action. For example, if the recommended action violates certain rules provided by the policies, the reinforcement learning module 5070 may provide negative feedback to the recommendation machine learning model 5060. The rules may include that the recommended action cannot be illegal, the recommended action cannot be inconsistent with the market status, the recommended action cannot be infeasible in view of the user's financial status, etc. Similarly, if the recommended action complies with certain or all rules provided by the policies, the reinforcement learning module 5070 may provide positive feedback to the recommendation machine learning model 5060. Based on the positive, negative, or neural feedback, the recommendation machine learning model 5060 may update its parameters such that it may be more likely to generate an information element or console data 5090 that receives positive feedback or maximum value as feedback.

After sufficient training with the human feedback from the feedback module 5080 and/or the feedback from the reinforcement learning module 5070, the information element generative model 5050 and the recommendation machine learning model 5060 may be capable of generating output that fit the human experts' preferences and/or the set of policies.

FIG. 9 is a block diagram of an example process for generating information elements implemented by a user interaction module 6000 of the AI-based engine 7000, according to some embodiments.

The user interaction module 6000 may generate a user interface. The user interaction module 6000 may receive (6202) user prompt 6070 via the user interface. The user prompt may be a question, a request for a document, a user's life event, etc. The user interaction module 6000 may transmit the user prompt 6070 to the neural console 5000.

In some embodiments, the user interaction module 6000 may receive information elements from the neural console. The information elements are generated by the neural console 5000 based on the user prompt 6070. As described above with respect to FIGS. 2A-2D, the information element may include an answer to a question to be presented via a chatbot window when the user prompt is a question submitted through the chatbot window. The information element may be a pre-meeting preparation document 6030 or post-meeting paperwork 6040 when the user prompt is a request for such documents. The information element may be life advice when the user prompt is a user's life event. The user interaction module may present information elements via a dashboard 6020 in the user interface.

In some embodiments, the user interaction module 6000 may receive console data 5090 from the neural console 5000. As described above, the user interaction module 6000 may generate information elements based on the console data 5090. The user interaction module 6000 may then present the information elements via a dashboard 6020 in the user interface.

### Example Generative Model

FIG. 10 depicts a structure of a neural network generative model 600, as an example of the generative model disclosed herein. It should be understood, however, that by including a self-attention mechanism (e.g., by adding position embeddings into input dataset) and configuring the neurons in a certain manner, the neural network generative model 600 may be a transformer model. After appropriate training, the neural network generative model 600 may be a generative pretrained transformer (GPT) model. One will appreciate other appropriate models may be used as non-GPT generative models, including but not limited to Naïve Bayes, Linear Regression, Logistic Regression, Support Vector Machine, etc.

The example generative model 600 has an input layer 602, one or more intermediate layers 604, 606, and an output layer 608. Each of the layers in the example generative model 600 may include one or more neurons x₁-y₂. The plurality of layers may chain neurons together linearly and may pass output from one neuron to the next, or may be networked together such that the neurons communicate input and output in a non-linear way. For example, each of the neurons h₁-h₄ may be a weighted sum of x₁-x₃, i.e.,

$${h}_{j} = {\sum }_{i = 1}^{n} {u}_{i j} {x}_{i} , j = 1 , 2 , … , m$$

where for the example generative model 600, n=3, and m=4.

In general, it should be understood that various configurations and/or connections of the example generative model 600 are possible. In an embodiment, the input layer may correspond to vectorized input. For example, if the example generative model 600 is the LLM 1070 for extracting and synthesizing information, an internal layer or external layer of the LLM 1070 may encode the text data of at least one of the user demographic information 1010, the portfolio data 1020, or the user communications 1030 into a set of vectors, such as (x₁, . . . , xₙ). The vectors are input to the LLM 1070 for further processing. Similarly, if the example generative model 600 is any of the generative models described above, an internal layer or external layer of the generative model may encode the its respective source input data into a set of vectors, such as (x₁, . . . , xₙ), for further processing. Each of the values of the vectors, i.e., x₁, . . . , xₙ, may be an input corresponding to a respective neuron in the input layer 602.

The input layer 602 may correspond to a large number of input values (e.g., one million inputs), in some embodiments, and may be analyzed serially or in parallel. Further, various neurons and/or neuron connections within the example generative model 600 may be initialized with any number of weights (such as the weights uᵢⱼ, tᵢⱼ, and wᵢⱼ). Each of the neurons in the intermediate layers 604, 606 may analyze one or more of the input parameters from the input layer, and/or one or more outputs from a previous one or more of the intermediate layers, to generate an output.

The output layer 608 may include one or more outputs, each indicating a respective result. For example, if the example generative model 600 is the LLM 1070, the output may be one or more set of vectors (y₁ . . . , yₙ). An internal or external layer may decode the set of vectors (y₁, . . . , yₙ) into texts, which is the extracted and synthesized information based on the at least one of the user demographic information 1010, the portfolio data 1020, or the user communications 1030. Similarly, if the example generative model 600 any of the generative models described above, an internal layer or external layer of the generative model may decode the its output vectors (y₁ . . . , yₙ) into respective output data in any appropriate form (e.g., numbers, texts, images, video, etc.).

### Example Training Process

FIG. 10 depicts a process for training the example generative model 600 of FIG. 9. One will appreciate other appropriate training techniques may be used. Some of the blocks in FIG. 10 may represent hardware and/or software components, other blocks may represent data structures or memory storing these data structures, registers, or state variables (e.g., 712), and other blocks may represent output data (e.g., 725). Input and/or output signals may be represented by arrows labeled with corresponding signal names and/or other identifiers.

The system and methods to generate and/or train a generative model (e.g., via the training module 170 of the training computing device 106), may consists of three steps: (1) a supervised training step, at which stage the generative model may represent a cursory model for what may be later developed and/or configured as the generative model; (2) a reward model step where human labelers may rank numerous generative model outputs to evaluate the output which best mimic preferred human output, generating comparison data, and be trained with on the comparison data; and/or (3) a policy optimization step in which the reward model may further improve the generative model. In one aspect, step one may take place only once, while steps two and three may be iterated continuously, e.g., more comparison data is collected on the current generative model, which may be used to optimize/update the reward model and/or further optimize/update the policy.

In some embodiments, a generative model may be pretrained before it undergoes the training stages (1)-(3) above. For example, the LLM 1070 for extracting and synthesizing information may be pretrained with the text data of the user demographic information 1010, the portfolio data 1020, or the user communications 103. More specifically, in the pretraining stage, the generative model may be required to predict a masked portion of a sentence (such as a sentence in a sample file specification), and adjust its parameters based on the difference between its predictions and the portion of the sentence that was under mask in a similar manner as described below with respect to the supervised training stage. One will appreciate that the generative model may be pretrained in other manners to learn text patterns.

### Supervised Training

In a first training stage 702, the training module 504 may train a generative model using supervised learning techniques. This training stage is described below with reference to both FIGS. 9 and 10.

Using the example generative model 600 in FIG. 10 as an example, the weights uᵢⱼ, tᵢⱼ, and wᵢⱼ are parameters of the model. One will appreciate that the generative model may include other parameters. For example, if zᵢ is calculated using hᵢ based on the weights tᵢⱼ and other parameters, such other parameters are also parameters of the example generative model 600.

When the training module 504 trains the example generative model 600, the training module 502 updates the weights uᵢⱼ, tᵢⱼ, wᵢⱼ and optionally other parameters iteratively. For example, when the example model 600 is the LLM 1070 for extracting and synthesizing information, to train it, the system may feed the example model 600 with a plurality of sample text sets as training datasets. Each sample text set includes sample user demographic information, sample portfolio data, and sample user communications. Each sample text set is associated with respective extracted and synthesized information. The example generative model 600 may receive the sample text sets (or its corresponding vector sets by encoding the sample text sets) at the input layer 602. The example generative model 600 may generate a set of output y₁ and y₂ using a set of randomly (or otherwise) initialized parameters uᵢⱼ, tᵢⱼ, and wᵢⱼ. The example generative model 600 may compute a change to the parameters uᵢⱼ, tᵢⱼ, and wᵢⱼ based on differences between the output y₁ and y₂ and the respective extracted and synthesized information (or its corresponding vector sets by encoding the extracted and synthesized information). The change may be proportional to the differences. For example, when the differences are greater, the changes to the parameters uᵢⱼ, tᵢⱼ, and wᵢⱼ are greater. To train other generative models described above, the system may feed the generative models with sample input data associated respective sample output data and compute the parameters in a similar manner.

Upon the parameters uᵢⱼ, tᵢⱼ, and wᵢⱼ converge to a certain range, that is, the changes to the parameters are smaller than a predetermined threshold, the generative model 600 may be determined to be ready for use or for further training as described below (corresponding to the model 715 in FIG. 11).

### Training Reward Model

In a second training stage 704, the training module 502 may train a reward model using human feedback (such as the human feedback provided by the feedback module 5080) or computer-generated feedback (such as the feedback generated by the reinforcement learning module 5070). The training module 502 may a reward model 720 to provide as an output a scaler value/reward 725. The reward model 720 may be required to leverage reinforcement learning with feedback in which a model (e.g., generative model 750) learns to produce outputs which maximize its reward 725, and in doing so may provide output which are better aligned to inputs.

Training the reward model 720 may provide training datasets 722. This input may be different from the training dataset described above. For example, to train the LLM 1070 for extracting and synthesizing information, the training dataset may include sample input text sets, but not include corresponding sample output information. Additionally, the training dataset used in the second stage 704 may be the data not seen by the generative model when it is trained in the first stage 702. Similarly, to train other generative models described above, the training dataset may include sample input data, but not include corresponding sample output data.

Based on training datasets 722, the generative model 715 may generate various outputs 724A. 724B, 724C, and 724D. In the embodiments where the feedback is human feedback, the system may present the output 724A, 724B, 724C, and 724D to a user interface device, such as a display (e.g., as text or graphical output), a speaker (e.g., as audio/voice output), and/or any other suitable manner of output of the output 724A, 724B, 724C, and 724D for review by the data labelers. In the embodiments where the feedback is computer-generated feedback, the system may transmit the output 724A, 724B, 724C, and 724D to a feedback computer module to obtain feedback.

The data labelers or the feedback computer module may provide feedback on the output 724A, 724B, 724C, and 724D when ranking 726 them from best to worst based on the input-output pairs. The data labelers may rank 726 the output 724A, 724B, 724C, and 724D by labeling the associated data. The ranked input-output pairs 728 may be used to train the reward model 720. The reward model 720 may provide as an output the scalar reward 725.

The scalar reward 725 may include a value numerically representing a human preference for the best and/or most expected output to an input. For example, inputting the “winning” input-output pair data to the reward model 720 may generate a winning reward. Inputting a “losing” input-output pair data to the same reward model 720 may generate a losing reward. The reward model 720 and/or scalar reward 725 may be updated based on ranking 726 additional input-output pairs.

### RLF Training

In a third training stage 706, the training module 502 may optimize the generative model using the reward model trained in the second stage.

The training module 502 may train the generative model 750 to generate an output 734 to a random, new and/or previously unknown input 732. To generate the output 734, the generative model 750 may use a policy 735 which it learns during training of the reward model 220, and in doing so may advance from the generative model 715 to the generative model 750. The policy 735 may represent a strategy that the generative model 750 learns to maximize the reward 725. Reflected in the inner structure of the generative model, the policy is implemented as a set of parameter values (e.g., the weights uᵢⱼ, tᵢⱼ, and wᵢⱼ) that allow the generative model to maximize the reward 725. As discussed herein, based on input-output pairs, a human labeler or a feedback computer module may continuously provide feedback to assist in determining how well the output of generative model 750 matches expected output to determine the rewards 725. The rewards 725 may feed back into the generative model 750 to evolve the policy 735, i.e., updating the parameters of the generative model. The training module 502 may update the policy 735 as the generative model 750 provides output 734 to additional inputs 732.

In one aspect, the output 734 of the generative model 750 using the policy 735 based on the reward 725 may be compared using a cost function 738 to the generative model 715 (which may not use a policy) output 736 of the same input 732. The cost function 738 may be trained in a similar manner and/or contemporaneous with the reward model 720. The system may compute a cost 740 based upon the cost function 738 of the output 734, 736. The cost 740 may reduce the distance between the output 734, 736, i.e., a statistical distance measuring how one probability distribution is different from a second, in one aspect the output 734 of the generative model 750 versus the output 736 of the model 715. Using the cost 740 to reduce the distance between the output 734, 736 may avoid a training module 502 over-optimizing the reward model 720 and deviating too drastically from the human-intended/preferred output. Without the cost 740, the generative model 750 optimizations may result in generating output 734 which are unreasonable but may still result in the reward model 720 outputting a high reward 725.

The output 734 of the generative model 750 using the current policy 735 may be passed by the training module 502 to the reward model 720, which may return the scalar reward 725. The output 734 of generative model 750 may be compared via the cost function 738 to the generative model 715 output 736 by the training module 502 to compute the cost 740. The training module 502 may generate a final reward 742 which may include the scalar reward 725 offset and/or restricted by the cost 740. The final reward 742 may be provided by the training module 502 to the generative model 750 and may update the policy 735, which in turn may improve the functionality of the generative model 750.

### Example Sequence Diagram

FIG. 12 is an example sequence diagram that illustrates a process 300 for generating information elements, according to some embodiments.

At block 310, the implementation computing device 104 may obtain, by one or more processors 140 via the neural console 5000, at least one of (a) a user profile 1120 from user profile module 1000, (b) a market performance report 2070 from market performance module 2000, (c) an industry report 3080 from industry report module 3000, or (d) a behavior report 4060 from behavior report module 4000, as described above with respect to step 5202.

In some embodiments, as described above with respect to FIG. 4, obtaining the user profile 1120 may include: (1) monitoring, by one or more processors 140 via the user profile module 1000, user data including at least one of demographic data 1010 of a user, portfolio data 1020 of a user, or communication data 1030 of a user; (2) responsive to detecting an update of the user data, via by one or more processors 140 via a large language model (LLM) 1070, extracting information from the update of the user data and synthesizing the information with existing user information to generate updated user information; (3) determining or updating, by one or more processors 140 via a user segmentation module 1080, one or more user segmentations of the user, of a plurality user segmentations, based on the update of the user data and the existing user information; (4) discovering, by the one or more processors 140 via a fuzzy logic module 1090, a data pattern based on the updated user information and the one or more user segmentations; (5) generating, by the one or more processors via a recommendation generative model 1100 based on the updated user information and the data pattern, a recommended action or a user profile improvement recommendation; and (6) transmitting, by the one or more processors to the neural console 5000, the user profile 1120 including the recommended action or the user profile improvement recommendation. In some embodiment, the user profile module 1000 may update the plurality of user segmentations based on the update of the user data.

In some embodiments, as described above with respect to FIG. 5, obtaining the market performance report 2070 may include: (1) receiving, by one or more processors 140 via market performance module 2000 at least one of (a) market performance indices 2010 in real time, (b) social media data 2020 associated with market performance in real time, (c) a market performance update detected from a webpage 2030 periodically; (2) determining, by one or more processors 140 via a decision machine learning model 2040, a set of metrics describing a market performance based on the market performance indices; (3) synthesizing, by one or more processors 140 via an information synthesis generative model 2050, information from the at least one of the social media data and the market performance update; and (4) generating, by one or more processors 140 via a market performance report generative model 2060, a market performance report 2070 based on the set of metrics and the synthesized information.

In some embodiments, as described above with respect to FIG. 6, obtaining the industry report 3080 may include: (1) receiving, by one or more processors 140 via an industry report module 3000, at least one of (a) an industry update detected from a webpage 3010 periodically, (b) social media data 3020 associated with industry information in real time, (c) industry news 3030 from a news source in real time, (d) an industry update detected from a blog or an article 3040 periodically, and (e) domain knowledge 3050 from a domain knowledge database periodically; (2) extracting, by one or more processors 140 via an information extraction generative model 3060, information of a topic from the at least one of (a) the industry update detected from the webpage 3010, (b) the social media data 3020, (c) the industry news 3030. (d) the industry update detected from the blog or the article 3040, and (e) the domain knowledge 3050; (3) generating or updating, by one or more processors 140 via an industry report generative model 3070, an industry report 3080 based on the extracted information; and (4) transmitting, by one or more processors 140, the industry report 3080 to the neural console 5000.

In some embodiments, the industry report module 3000 includes a label generative model. The industry report module 3000 may label industry news in the following manner: (1) receiving, a piece of industry news from a news source; (2) generating, via the label generative model, one or more candidate labels and respective confidence levels for the piece of news; (3) selecting at least one label from the one or more candidate labels based on the respective confidence levels; and (4) associating the at least one label with the piece of industry news.

In some embodiments, the industry report module 3000 selectively collect and/or analyze news in the following manner: (1) receiving the user prompt 6070 from the user interaction module 6000; (2) determining a relevance level between the user prompt and the at least one label associated with the piece of industry news; and (3) responsive to the relevance level being above a threshold relevance level, analyzing the piece of industry news to generate the industry report 3080.

In some embodiments, as described above with respect to FIG. 7, obtaining the behavior report 4060 may include: (1) receiving, by one or more processors 140, at least one of a user behavior 4010 or an industry behavior 4020; (2) determining, by one or more processors 140 via a behavior pattern machine learning model 4030, a behavior pattern from the at least one of the user behavior 4010 or the industry behavior 4020; performing, via a sentiment analysis generative model 4040, a sentiment analysis on the at least one of the user behavior 4010 or the industry behavior 4020 to obtain an analysis result; (3) predicting, by one or more processors 140 via a behavior prediction machine learning model 4050, at least one of a future user behavior or a future industry behavior based on the behavior pattern and the analysis result; (4) generating, by one or more processors 140, a behavior report 4060 including (a) the at least one of the user behavior or the industry behavior and (b) the at least one of the future user behavior or the future industry behavior; and (5) transmitting, by one or more processors 140, a behavior report 4060 to the neural console 5000.

At block 320, the implementation computing device 104 may receive, by the one or more processors 140 via the neural console 5000, a user prompt 6070 from user interface 200, as described above with respect to step 5204. In some embodiments, the user interface 200 is generated by the user interaction module 6000, as described above with respect to FIG. 9.

At block 330, the implementation computing device 104 may generate, by the one or more processors 140 via the neural console 5000, console data 5090 via the information element generative model 5050 based on the user prompt 6070 and the at least one of the user profile 1120, the market performance report 2070, the industry report 3080, or the behavior report 4060, as described above with respect to the information element generative model 5050.

In some embodiments, as described above with respect to FIG. 8, generating the console data 5090 includes: (1) determining, by the one or more processors 140 via a recommendation machine learning model 5060, a recommended action based on the user prompt 6070 and the at least one of the user profile 1120, the market performance report 2070, the industry report 3080, or the behavior report 4060; and (2) generating, by the one or more processors 140, the console data 5090 based on the recommended action.

In some embodiments, the neural console 5000 may further (1) associate the recommended action with one or more metrics, and (2) update the recommendation machine learning model using the recommended action and the one or more metrics.

At block 340, the implementation computing device 104 may generate, by one or more processors via the user interaction module 6000, an information element based on the console data 5090, as described above with respect to FIG. 9.

In some embodiments, as described above with respect to FIG. 9, the user prompt 6070 is a question on a topic, and the information element is an answer to the question on the topic. In some embodiments, the user prompt 6070 is a request for documents on a topic, and the information element is a document on the topic. In some embodiments, the document on the topic is a meeting preparation document. In some embodiments, the user prompt 6070 is a life event of a user, and the information element is a life advice 6060 based on the life event.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, and/or may be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining.” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate still additional alternative structural and functional designs for evaluation properties, through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A computing system for generating information elements, comprising:
one or more processors; and
one or more memories having stored thereon:
(i) an information element generative model;
(ii) a set of user profile computer-executable instructions that, when executed by the one or more processors, cause a user profile module to provide user profiles;
(iii) a set of market performance report computer-executable instructions that, when executed by the one or more processors, cause a market performance module to provide market performance reports;
(iv) a set of industry report computer-executable instructions that, when executed by the one or more processors, cause an industry report module to provide industry reports;
(v) a set of behavior report computer-executable instructions that, when executed by the one or more processors, cause a behavior report module to provide behavior reports;
(vi) a set of user interaction computer-executable instructions that, when executed by the one or more processors, cause a user interaction module to:
generate a user interface;
receive a user prompt via the user interface;
transmit the user prompt to a neural console;
receive console data from the neural console;
generate an information element based on the console data; and
present the information element via the user interface; and
(v) a set of neural console computer-executable instructions, when executed by the one or more processors, cause the neural console to:
receive at least one of (a) a user profile from the user profile module, (b) a market performance report from the market performance module, (c) an industry report from the industry report module, or (d) a behavior report from the behavior report module;
receive the user prompt from the user interaction module;
generate the console data via the information element generative model based on the user prompt and the at least one of the user profile, the market performance report, the industry report, or the behavior report; and
transmit the console data to the user interaction module.

2. The computing system of claim 1, wherein:
the one or more memories further have stored thereon:
(i) a large language model (LLM),
(ii) a recommendation generative model, and
(iii) a set of fuzzy logic computer-executable instructions, when executed by the one or more processors, cause a fuzzy logic module to perform fuzzy logic analysis; and
the set of user profile computer-executable instructions, when executed by the one or more processors, cause the user profile module to:
monitor user data, including at least one of demographic data of a user, portfolio data of a user, or communication data of a user;
responsive to detecting an update of the user data, via the large language model (LLM), extract information from the update of the user data and synthesize the information with existing user information to generate updated user information;
determine or update one or more user segmentations of the user, of a plurality user segmentations, based on the update of the user data and the existing user information;
discover a data pattern based on the updated user information and the one or more user segmentations via the fuzzy logic module;
generate, based on the updated user information and the data pattern, a recommended action or a user profile improvement recommendation via the recommendation generative model; and
transmit, to the neural console, the user profile including the recommended action or the user profile improvement recommendation.

3. The computing system of claim 2, wherein the set of user profile computer-executable instructions, when executed by the one or more processors, cause the user profile module to:
update the plurality of user segmentations based on the update of the user data.

4. The computing system of claim 1, wherein:
the one or more memories further have stored thereon:
(i) a decision machine learning model,
(ii) an information synthesis generative model, and
(iii) a market performance report generative model; and
the set of market performance report computer-executable instructions, when executed by the one or more processors, cause the market performance module to:
receive at least one of (a) market performance indices in real time, (b) social media data associated with market performance in real time, (c) a market performance update detected from a webpage periodically;
determine, via the decision machine learning model, a set of metrics describing a market performance based on the market performance indices;
synthesize, via the information synthesis generative model, information from the at least one of the social media data and the market performance update; and
generate, via the market performance report generative model, the market performance report based on the set of metrics and the synthesized information.

5. The computing system of claim 1, wherein:
the one or more memories further have stored thereon:
(i) an information extraction generative model, and
(ii) an industry report generative model; and
the set of industry report computer-executable instructions, when executed by the one or more processors, cause the industry report module to:
receive at least one of (a) an industry update detected from a webpage periodically, (b) social media data associated with industry information in real time, (c) industry news from a news source in real time, (d) an industry update detected from a blog or an article periodically, and (e) domain knowledge from a domain knowledge database periodically;
extract, via the information extraction generative model, information of a topic from the at least one of (a) the industry update detected from the webpage, (b) the social media data, (c) the industry news, (d) the industry update detected from the blog or the article, and (e) the domain knowledge;
generate or update, via the industry report generative model, the industry report based on the extracted information; and
transmit the industry report to the neural console.

6. The computing system of claim 1, wherein:
the one or more memories further have stored thereon a label generative model; and
the set of industry report computer-executable instructions, when executed by the one or more processors, cause the industry report module to:
receive a piece of industry news from a news source;
generate, via the label generative model, one or more candidate labels and respective confidence levels for the piece of news;
select at least one label from the one or more candidate labels based on the respective confidence levels; and
associate the at least one label with the piece of industry news.

7. The computing system of claim 6, wherein the set of industry report computer-executable instructions, when executed by the one or more processors, cause the industry report module to:
receive the user prompt from the user interaction module;
determine a relevance level between the user prompt and the at least one label associated with the piece of industry news; and
responsive to the relevance level being above a threshold relevance level, analyze the piece of industry news to generate the industry report.

8. The computing system of claim 1, wherein:
the one or more memories further have stored thereon:
(i) a behavior pattern machine learning model,
(ii) a sentiment analysis generative model, and
(iii) a behavior prediction machine learning model; and
the set of behavior report computer-executable instructions, when executed by the one or more processors, cause the behavior report module to:
receive at least one of a user behavior or an industry behavior;
determine, via the behavior pattern machine learning model, a behavior pattern from the at least one of the user behavior or the industry behavior;
perform, via the sentiment analysis generative model, a sentiment analysis on the at least one of the user behavior or the industry behavior to obtain an analysis result;
predict, via the behavior prediction machine learning model, at least one of a future user behavior or a future industry behavior based on the behavior pattern and the analysis result;
generate the behavior report including (a) the at least one of the user behavior or the industry behavior and (b) the at least one of the future user behavior or the future industry behavior; and
transmit the behavior report to the neural console.

9. The computing system of claim 1, wherein:
the one or more memories further have stored thereon a recommendation machine learning model; and
to generate the console data, the set of neural console computer-executable instructions, when executed by the one or more processors, causes the neural console to:
determine, via the recommendation machine learning model, a recommended action based on the user prompt and the at least one of the user profile, the market performance report, the industry report, or the behavior report; and
generate the console data based on the recommended action.

10. The computing system of claim 9, wherein the set of neural console computer-executable instructions, when executed by the one or more processors, causes the neural console to:
associate the recommended action with one or more metrics; and
update the recommendation machine learning model using the recommended action and the one or more metrics.

11. The computing system of claim 1, wherein:
the user prompt is a question on a topic; and
the information element is an answer to the question on the topic.

12. The computing system of claim 1, wherein:
the user prompt is a request for documents on a topic; and
the information element is a document on the topic.

13. The computing system of claim 12, wherein:
the document on the topic is a meeting preparation document.

14. The computing system of claim 1, wherein:
the user prompt is a life event of a user; and
the information element is a life advice based on the life event.

15. A computer-implemented method for generating information elements, comprising:
obtaining, by one or more processors, at least one of (a) a user profile, (b) a market performance report, (c) an industry report, or (d) a behavior report;
receiving, by one or more processors, a user prompt from user interface;
generating, by one or more processors, console data via an information element generative model based on the user prompt and the at least one of the user profile, the market performance report, the industry report, or the behavior report; and
generating, by one or more processors, an information element based on the console data.

16. The computer-implemented method of claim 15, comprising obtaining the user profile, wherein obtaining the user profile includes:
monitoring, by one or more processors, user data including at least one of demographic data of the user, portfolio data of the user, or communication data of the user;
responsive to detecting an update of the user data, extracting, by one or more processors via a large language model (LLM), information from the update of the user data and synthesizing the information with existing user information to generate updated user information;
determining or updating, by one or more processors, one or more user segmentations of the user, of a plurality user segmentations, based on the update of the user data and the existing user information;
discovering, by one or more processors, a data pattern based on the updated user information and the one or more user segmentations by performing fuzzy logic analysis;
generating, by one or more processors via a recommendation generative AI, a recommended action or a user profile improvement recommendation; and
associating, by one or more processors, the recommended action or the user profile improvement recommendation with the user profile.

17. The computer-implemented method of claim 15, comprising obtaining the market performance report, wherein obtaining the market performance report includes:
receiving, by one or more processors, at least one of (a) a market performance index in real time, (b) social media data associated with market performance in real time, (c) a market performance update detected from a website periodically;
determining, by one or more processors via a recommendation machine learning model, a recommended action based on the at least one of (a) the market performance index, (b) the social media data, (c) the market performance update;
synthesizing, by one or more processors via an information synthesis generative model, information from the at least one of (a) the market performance index, (b) the social media data, (c) the market performance update; and
generating, by one or more processors via a market performance report generative model, the market performance report based on the recommended action and the synthesized information.

18. The computer-implemented method of claim 15, comprising obtaining the industry report, wherein obtaining the industry report includes:
receiving, by one or more processors, at least one of (a) an industry update detected from a webpage periodically, (b) social media data associated with industry information in real time, (c) industry news from a news source in real time, (d) an industry update detected from a blog or an article periodically, and (e) an industry update detected from a domain knowledge database;
extracting, by one or more processors via an information extraction generative model, information of a topic from the at least one of (a) the industry update detected from the webpage, (b) the social media data, (c) the industry news, (d) the industry update detected from the blog or the article, and (e) the industry update detected from the domain knowledge database; and
generating or updating, by one or more processors via an industry report generative model, the industry report based on the extracted information.

19. The computer-implemented method of claim 15, comprising obtaining the behavior report, wherein obtaining the behavior report includes:
receiving, by one or more processors, at least one of a user behavior or an industry behavior;
determining, by one or more processors via a behavior pattern machine learning model, a behavior pattern from the at least one of the user behavior or the industry behavior;
performing, by one or more processors via a sentiment analysis generative model, a sentiment analysis on the at least one of the user behavior or the industry behavior to obtain an analysis result;
predicting, by one or more processors via a behavior prediction machine learning model, based on the behavior pattern and the analysis result at least one of a future user behavior or a future industry behavior; and
generating, by one or more processors, the behavior report including the at least one of the user behavior or the industry behavior and the at least one of the future user behavior or the future industry behavior.

20. The computer-implemented method of claim 15, wherein generating the console data includes:
determining, by one or more processors via a recommendation machine learning model, a recommended action based on the user prompt and the at least one of the user profile, the market performance report, the industry report, or the behavior report; and
generating, by one or more processors, the console data based on the recommended action.
